(19) United States
(12) Patent Application Publication
(10) Pub. No.: US 2023/0417268 A1
(43) Pub. Date: Dec. 28, 2023

(54) Stud Fastener System

(71) Applicant: Illinois Tool Works Inc., Glenview, IL (US)

(72) Inventors: Timothy D. Pearson, New Lenox, IL (US); Kileean E. Bell, Monee, IL (US)

(21) Appl. No.: 18/208,778

(22) Filed: Jun. 12, 2023

Related U.S. Application Data
(60) Provisional application No. 63/355,280, filed on Jun. 24, 2022.

(51) Int. Cl. F16B 21/08

(52) U.S. Cl. CPC F16B 21/086

(57) ABSTRACT

The body defines a central longitudinal axis and includes a sidewall that defines a hollow space configured to receive the stud. The three or more retention features are resiliently coupled to an interior surface of the sidewall and configured to retain the stud within the hollow space. Each of the three or more retention features are angled toward the central longitudinal axis and are configured to deflect outward from the central longitudinal axis as the stud passes through the hollow space. In some examples, the stud fastener is fabricated via an additive manufacturing technique.

### RELATED APPLICATION

The present application claims priority to U.S. Provisional Patent Application No. 63/355,280, filed Jun. 24, 2022, and entitled “Stud Fastener System,” which is hereby incorporated by reference in its entirety.

### BACKGROUND

Automotive components require fastening techniques that are simple to manufacture and assemble. Further, fastening techniques should above all be reliable and efficient. A blind, close-panel assembly is a condition where the fastening is focused between the panels being fastened to each other (such as automotive panels or other components), while trying to keep those same panels positioned very closely to each other.

Typical fastening solutions that allow this type of closely-positioned assembly include, magnets, adhesive tape, and mechanical fasteners. For example, a stud fastener (whether metal or plastic) can be used to make a blind connection between panels by engaging a stud associated with one of the two panels. Despite advancements to date, it would be highly desirable to have a stud fastener assembly with improved assembly characteristics that provides reliable and secure fastening.

### SUMMARY

The present disclosure relates generally to a fastening system to form a connection between the components, such as automotive panels, using a stud fastener with improved characteristics, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate, respectively, assembly and assembled side views of an example fastening systems configured to form a blind connection between components in accordance with aspects of this disclosure.

FIG. 2a illustrates a topside isometric view of a 3-legged stud fastener in accordance with aspects of this disclosure.

FIG. 2b illustrates an underside isometric view of the 3-legged stud fastener of FIG. 2a.

FIGS. 2c and 2d illustrate, respectively, top plan and bottom plan views of the 3-legged stud fastener of FIG. 2a.

FIG. 2e illustrates a cross-sectional side view of the 3-legged stud fastener taken along cutline A-A of FIG. 2c.

FIG. 2f illustrates a cross-sectional view of the 3-legged stud fastener taken along cutline B-B of FIG. 2c.

FIG. 3a illustrates a topside isometric view of a recessed 3-legged stud fastener in accordance with an aspect of this disclosure.

FIG. 3b illustrates an underside isometric view of the recessed 3-legged stud fastener of FIG. 3a.

FIGS. 3c and 3d illustrate, respectively, top plan and bottom plan views of the recessed 3-legged stud fastener of FIG. 3a.

FIGS. 3e and 3f illustrate, respectively, cross-sectional views of the recessed 3-legged stud fastener taken along cutline C-C of FIG. 3d and cutline D-D of FIG. 3d.

FIG. 4a illustrates a topside isometric view of a stud fastener in accordance with another aspect of this disclosure.

FIG. 4b illustrates an underside isometric view of the stud fastener of FIG. 4a.

FIGS. 4c and 4d illustrate, respectively, cross-sectional views of the stud fastener taken along cutline E-E of FIG. 4a and cutline F-F of FIG. 4b.

FIGS. 4e through 4g illustrate, respectively, top plan, side elevation, and bottom plan views of the stud fastener of FIG. 4a.

FIG. 4h illustrates a cross-sectional view of the stud fastener taken along cutline G-G of FIG. 4g.

FIG. 5a illustrates a topside isometric view of a stud fastener in accordance with another aspect of this disclosure.

FIG. 5b illustrates an underside isometric view of the stud fastener of FIG. 5a.

FIGS. 5c and 5d illustrate, respectively, cross-sectional views of the stud fastener taken along cutline G-G of FIG. 5a and cutline H-H of FIG. 5b.

FIGS. 5e through 5f illustrate, respectively, top plan and bottom plan views of the stud fastener.

FIGS. 5g and 5h illustrate, respectively, cross-sectional views of the stud fastener taken along cutline I-I of FIG. 5f and cutline J-J of FIG. 5f.

FIG. 6a illustrates a topside isometric view of a stud fastener with reduced material in accordance with another aspect of this disclosure.

FIG. 6b illustrates an underside isometric view of the stud fastener of FIG. 6a.

FIGS. 6c through 6f illustrate, respectively, top plan, bottom plan, first side, and second side views of the stud fastener of FIG. 6a.

FIG. 6g illustrates a cross-sectional view of the stud fastener taken along cutline H-H of FIG. 6d.

FIG. 6h illustrates a cross-sectional view of the stud fastener taken along cutline I-I of FIG. 6d.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a blind connection between a first component and a second component, such as automotive panels. In some examples, the fastener can be integrated with one of the first component or the second component. Integrated fasteners, as disclosed herein, offer lower cost automotive components with integrated fasteners, by reducing part numbers, complexity of inventory management, and eliminating the need to handle and assemble fasteners. Such fasteners also provide improved characteristics.

In one example, a stud fastener for attaching a first component to a stud of a second component comprises: a body defining a central longitudinal axis, wherein the body includes a sidewall that defines a hollow space configured to receive the stud; and three or more retention features resiliently coupled to an interior surface of the sidewall and configured to retain the stud within the hollow space. The sidewall may be any suitable shape as needed for a given stud shape, such as cylindrical, rectangular, and the like. Each of the three or more retention features are angled toward the central longitudinal axis and are configured to deflect outward from the central longitudinal axis as the stud passes through the hollow space.

In some examples, three or more retention features are spaced about the central longitudinal axis from one another by 120 degrees. In some examples, the body defines a recess within the sidewall. In some examples, each of the three or more retention features are coupled to the body within the recess. In some examples, the body and the three or more retention features are fabricated as a unitary structure via an additive manufacturing technique.

In some examples, each of the one or more retention features includes a return arm resiliently connected to the body and configured to deflect as the as the stud passes through the hollow space. In some examples, each of the retention features 206 comprises a foot position at a distal end of the return arm. In some examples, the foot comprises one or more friction features.

In some examples, the stud fastener further comprises one or more secondary retention features vertically offset from the three or more retention features. In some examples, at least one of the one or more secondary retention features is aligned vertically with each of the three or more retention features. In some examples, each of the one or more secondary retention features comprises a secondary return arm and a secondary foot. In some examples, the stud fastener further comprises one or more shims vertically offset from the three or more retention features. In some examples, at least one of the one or more shims is aligned vertically with each of the three or more retention features. In some examples, the body defines a leading end that is open to receive the stud and a base end. In some examples, the base end is either closed or open. In some examples, the leading end of the body is chamfered along an inner perimeter to align and guide the stud during assembly. In some examples, the sidewall defines a first inner diameter that corresponds to an outer diameter of the stud to mitigate side-to-side movement of a distal end of the stud once assembled. In some examples, the sidewall defines one or more windows. In some examples, the stud fastener is fabricated as a unitary structure with the first component via an additive manufacturing technique.

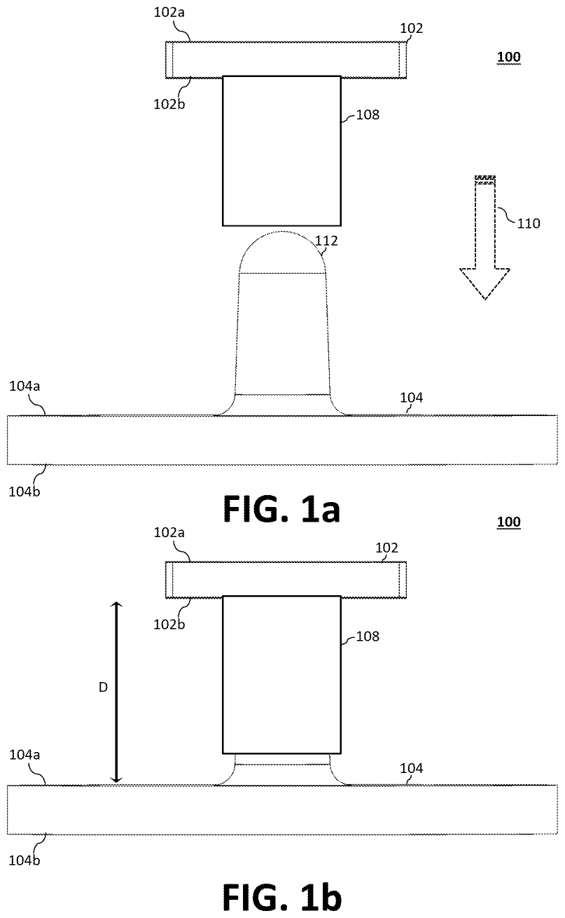

FIGS. 1a and 1b illustrate side views of example fastening system 100 configured to form a blind connection between a first component 102 and a second component 104. The first component 102 and the second component 104 may be, for example, automotive panels or other components thereof. Depending on the application, one or both of the first component 102 and/or the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In one example, the first component 102 is an automotive secondary component and the second component 104 is an automotive primary component. In the automotive industry, example first components 102 include, without limitation, door trim panels, moldings, trim pieces, and other substrates (whether used as interior or exterior surfaces).

The first component 102 may define an A-side surface 102a (e.g., a first surface) and a B-side surface 102b (e.g., a second surface, illustrated as an undersurface). The A-side surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-side surface 102b, also called a class B surface, is typically the surface that is not visible after assembly and typically includes various attachment devices and/or related features.

The first component 102 may include, define, or otherwise provide a stud fastener 108, which can be integrated with the first component 102 or attached during assembly (e.g., via adhesives, a welding process, a mechanical coupling, or the like). Depending on the material type, the stud fastener 108 may be formed on the B-side surface 102b during manufacturing of the first component 102, whether via printing (e.g., an addition manufacturing process), molding, or layup. After the first component 102 and the second component 104 are assembled, the second component 104 is covered at least partially by the first component 102. The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. The second component 104 may likewise define an A-side surface 104a (e.g., a first surface, such as an exterior surface) and a B-side surface 104b (e.g., a second surface, such as an interior surface).

As will become apparent, the second component 104 may include, define, or otherwise provide a stud 112 (or post), which may be likewise formed during manufacturing of the second component 104 or attached during assembly. To form the blind connection between the first component 102 and the second component 104, the stud fastener 108 is inserted over and slides onto the stud 112 formed in or on a surface of the second component 104 as indicated by the arrow 110. By integrating the stud fastener 108 with the first component 102, the fastening system 100 eliminates setup variation, reduced the number of parts (and part numbers), while allowing for a relatively close assembled distance (D) between the first and second components 102, 104 (i.e., that between the A-side surface 102a and the B-side surface 104b) because there is no need for a clip-attachment structure for the stud fastener (e.g., a dog house, blade, etc.). In some examples, the first component 102 and/or the stud fastener 108 may include additional features, such as ribs and wings to mitigate noise and/or rattle between the first and second components 102, 104.

The first component 102 and the stud fastener 108 may be formed as a unitary structure. For example, the first component 102 and the stud fastener 108 may be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the stud fastener 108 may be fabricated with the first component 102 using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μall). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the first component 102 and the stud fastener 108 may be formed or otherwise fabricated at different resolutions during a printing operation. For example, the stud fastener 108 portion may be printed at a higher resolution than that of the first component 102 or vice versa as needed for a particular application.

While it is contemplated that the first component 102 and the stud fastener 108 would be formed during the same printing session (i.e., printed during the same printing operation), it is possible that the stud fastener 108 may be printed onto a preexisting first component 102. For example, the first component 102 may be printed with one or more landmark structures (e.g., a protrusion or a recess) during a first session that can be located and filled and/or surrounded with material during a second session to form the stud fastener 108. As will be discussed, the stud fastener 108 may be fabricated in various forms and/or designs.

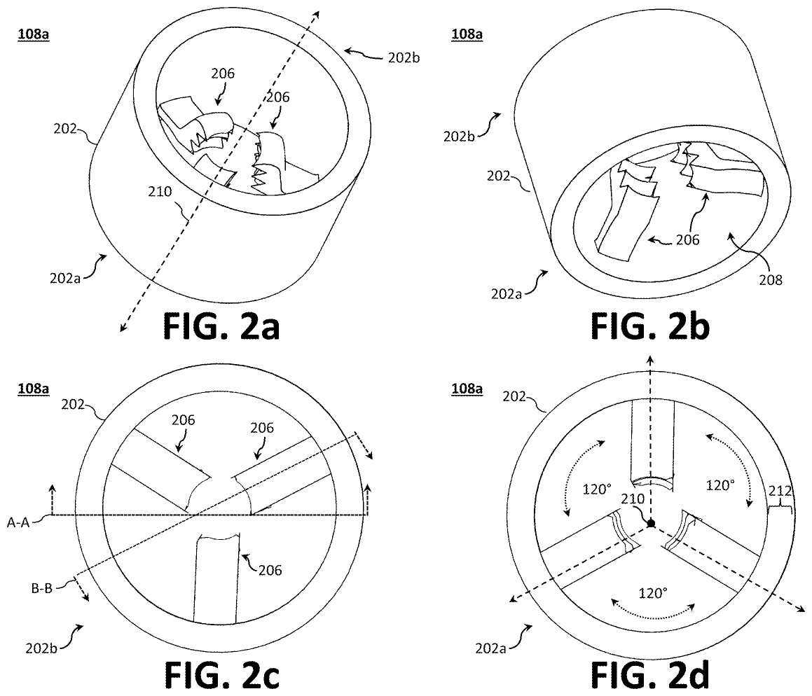

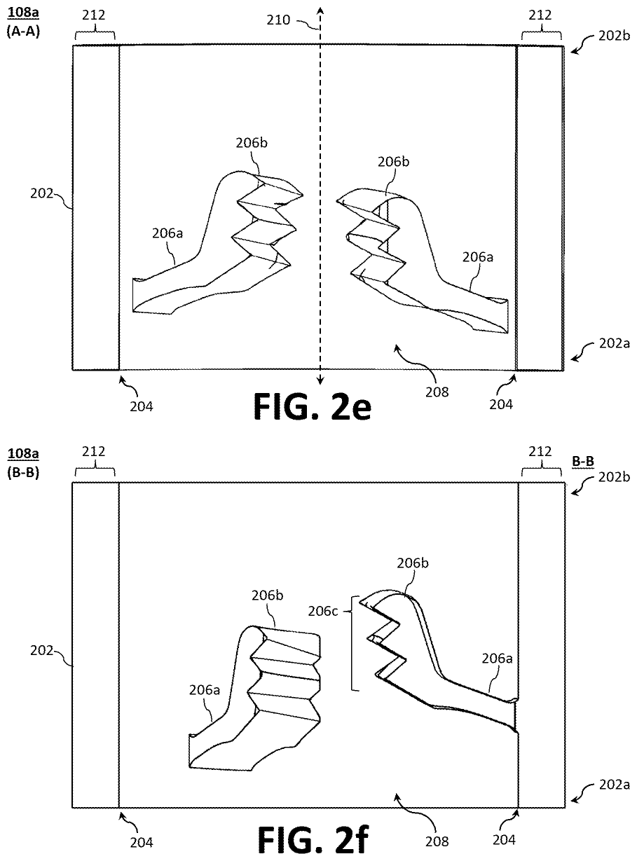

FIGS. 2a through 2f illustrate an example 3-legged stud fastener 108a. FIG. 2a illustrates a topside isometric view of the 3-legged stud fastener 108a, while FIG. 2b illustrates an underside isometric view thereof. FIGS. 2c and 2d illustrate, respectively, top plan and bottom plan views of the 3-legged stud fastener 108a. FIG. 2e illustrates a cross-sectional side view of the 3-legged stud fastener 108a taken along cutline A-A (FIG. 2c), while FIG. 2f illustrates a cross-sectional view of the 3-legged stud fastener 108a taken along cutline B-B (FIG. 2c). The 3-legged stud fastener 108a is configured to receive and engage (or otherwise retain) the second component 104 via the retention features 206 and the stud 112.

The 3-legged stud fastener 108a can be provided as a separate fastener that can be attached to a component at the base end 202b, or instead be integrated with the first component 102 as described above. As illustrated, the 3-legged stud fastener 108a generally comprises a body 202 that defines (or otherwise includes) a hollow space 208 with three or more retention features 206. In this example, the body 202 is illustrated as a hollow barrel generally defining a cylindrical sidewall 212 that surrounds the hollow space 208. While the body 202 is illustrated and generally described as a hollow barrel generally defining a cylindrical sidewall 212, the sidewall may be any suitable shape as needed for a given stud shape, including rectangular and other shapes.

The body 202 defines a leading wend 202a configured to receive the stud 112 and a base end 202b. The illustrated 3-legged stud fastener 108a (e.g., via the body 202) further defines a central longitudinal axis 210 that passes through the hollow space 208 between the leading end 202a and the base end 202b. The central longitudinal axis 210 is generally perpendicular to a plane defined by the base end 202b of the body 202 (and often perpendicular to the first component 102, which is would be the case with flat panels, as an example).

As illustrated, the body 202 forms the hollow space 208 within the cylindrical sidewall 212 and between the leading end 202a and the base end 202b to retain the stud 112. In the illustrated example, each of the leading end 202a and the base end 202b are open. As a result, depending on the stud length, a stud 112 can pass through the leading end 202a into the hollow space 208, engage the three or more retention features 206, and exit (at least partially) out of the base end 202b. While the leading end 202a and the base end 202b are each illustrated as open, as will be described in connection with other examples, the base end 202b may be closed and/or obstructed by the first component 102.

The leading end 202a can be rounded, tapered, or otherwise shaped to increase insertion ease of the stud 112 to the body 202. For example, the leading end 202a of the body 202 can be chamfered along the inner perimeter 204 to help align and guide the stud 112 into the body 202 during assembly.

The plurality of retention features 206 extend inwardly from an interior surface of the cylindrical sidewall 212 of the body 202 into the hollow space 208 to retain the stud 112. In some examples, as illustrated, three retention features 206 are arranged about the central longitudinal axis 210 and spaced from one another by 120 degrees (as best illustrated in FIG. 2d). Providing three retention features 206 results in a stable engagement with the stud 112 by providing 3 points of contact, thus mitigating side-to-side movement (e.g., lateral movement). While three retention features 206 are illustrated, one of skill in the art would appreciate that additional retention features 206 may be used. For example, four retention features 206 may be arranged about the central longitudinal axis 210 and spaced from one another by 90 degrees, five retention features 206 may be arranged about the central longitudinal axis 210 and spaced from one another by 72 degrees, and so forth.

The retention features 206 are inwardly biased and resiliently connected to the body 202. As illustrated, each of the one or more retention features 206 includes a return arm 206a resiliently connected to the body 202 and configured to deflect as the 3-legged stud fastener 108a is passed onto the stud 112 associated with the second component 104. A foot 206b is formed or located at an end of the return arm 206a and configured to engage the stud 112 via interference fit (e.g., at the outer surface of the stud 112). The foot 206b may include one or more friction features 206c to increase friction contact with the stud 112. Example friction features 206c include ridges, teeth, roughened surface, and the like. The retention features 206 are relatively rigid towards outward forces and as such will lock the 3-legged stud fastener 108a onto the stud 112.

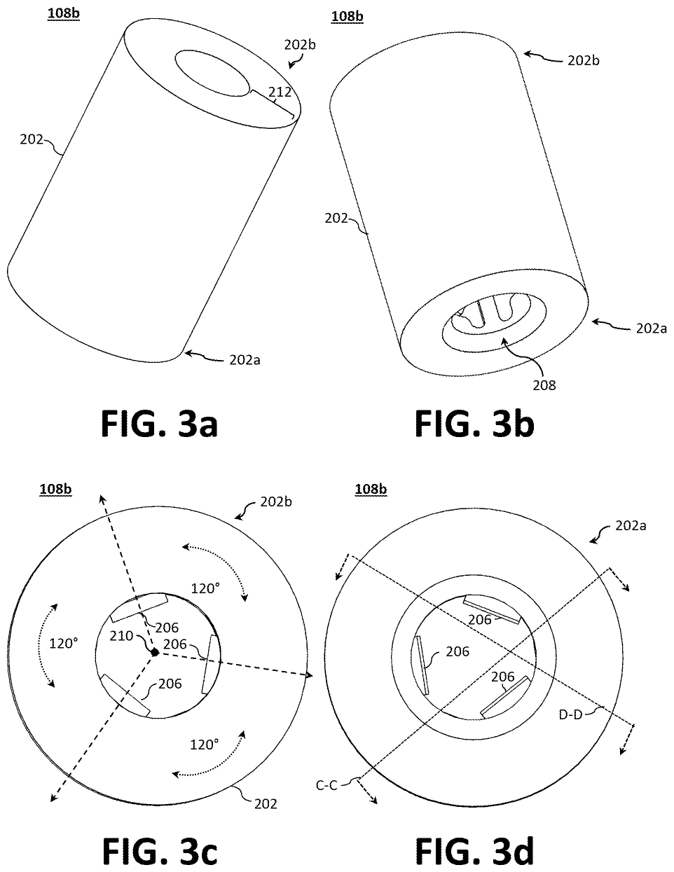

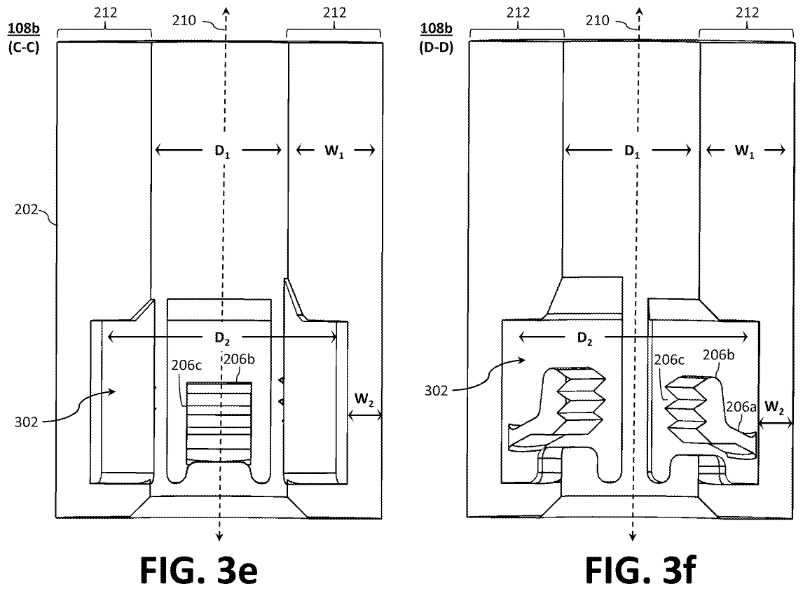

FIGS. 3a through 3f illustrate an example recessed 3-legged stud fastener 108b. FIG. 3a illustrates a topside isometric view of the recessed 3-legged stud fastener 108b, while FIG. 3b illustrates an underside isometric view thereof. FIGS. 3c and 3d illustrate, respectively, top plan and bottom plan views of the recessed 3-legged stud fastener 108b. FIGS. 3e and 3f illustrate, respectively, cross-sectional views of the recessed 3-legged stud fastener 108b taken along cutline C-C (FIG. 3d) and cutline D-D (FIG. 3d). The recessed 3-legged stud fastener 108b is configured to receive and engage (or otherwise retain) the second component 104 via the retention features 206 and the stud 112.

The recessed 3-legged stud fastener 108b can be provided as a separate fastener that can be attached to a component at the base end 202b, or instead be integrated with the first component 102 as described above. As illustrated, the recessed 3-legged stud fastener 108b generally comprises a body 202 that defines (or otherwise includes) a hollow space 208 with three or more retention features 206. In this example, the body 202 is again illustrated as a hollow barrel generally defining a cylindrical sidewall 212. The example recessed 3-legged stud fastener 108b of FIGS. 3a through 3f is substantially the same as the 3-legged stud fastener 108a of FIGS. 2a through 2f, except that the cylindrical sidewall 212 is shaped to define a recess 302 within the hollow space 208. The recess 302 may be annular in shape. For example, as best illustrated in FIGS. 3e and 3f, the thickness (W₂) of the cylindrical sidewall 212 at the leading end 202a is thinner than the thickness (W₁) of the cylindrical sidewall 212 at the base end 202b to define the recess 302. As a result, the hollow space 208 has a first inner diameter (D₁) at the base end 202b that is less than a second inner diameter (D₂) of the recess 302, which is positioned at or near the leading end 202a.

The retention features 206 are inwardly biased and resiliently connected to the body 202. The plurality of retention features 206 extend inwardly from an interior surface of the recess 302 into the hollow space 208 to retain the stud 112. As illustrated, each of the one or more retention features 206 includes a return arm 206a, a foot 206b, and one or more friction features 206c. In some examples, as illustrated, three retention features 206 are arranged about the central longitudinal axis 210 and spaced from one another by 120 degrees (as best illustrated in FIG. 3e). Providing three retention features 206 results in a stable engagement with the stud 112 by providing 3 points of contact, thus mitigating side-to-side movement. Further, positioning the plurality of retention features 206 in the recess 302 allows for a body 202 with a smaller outer diameter because a portion of each retention features 206 is recessed. In addition, the thicker portion (e.g., thickness (W₂)) of the cylindrical sidewall 212 at the leading end 202a can be sized to provide a first inner diameter (D₁) that corresponds to the outer diameter of the stud 112 to mitigate side-to-side movement of the distal end of the stud 112 once assembled.

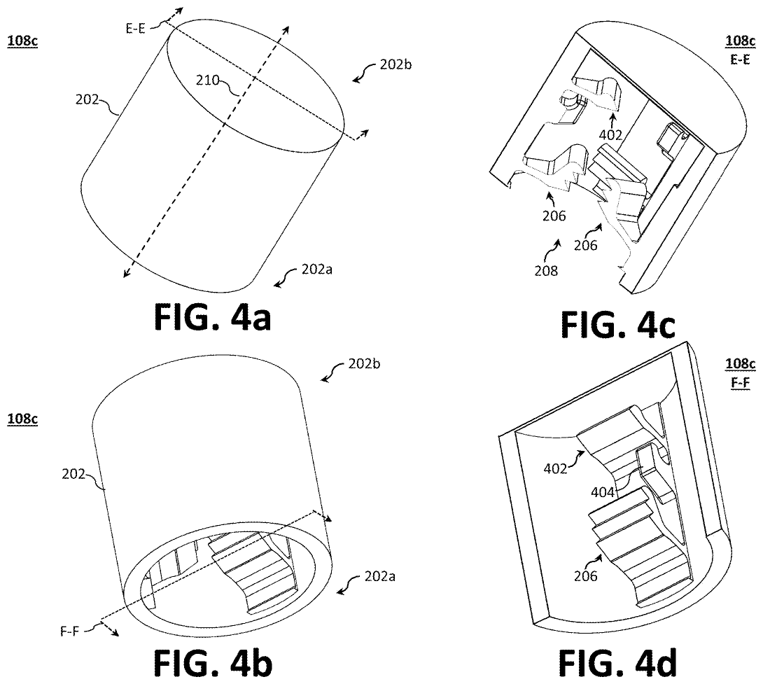

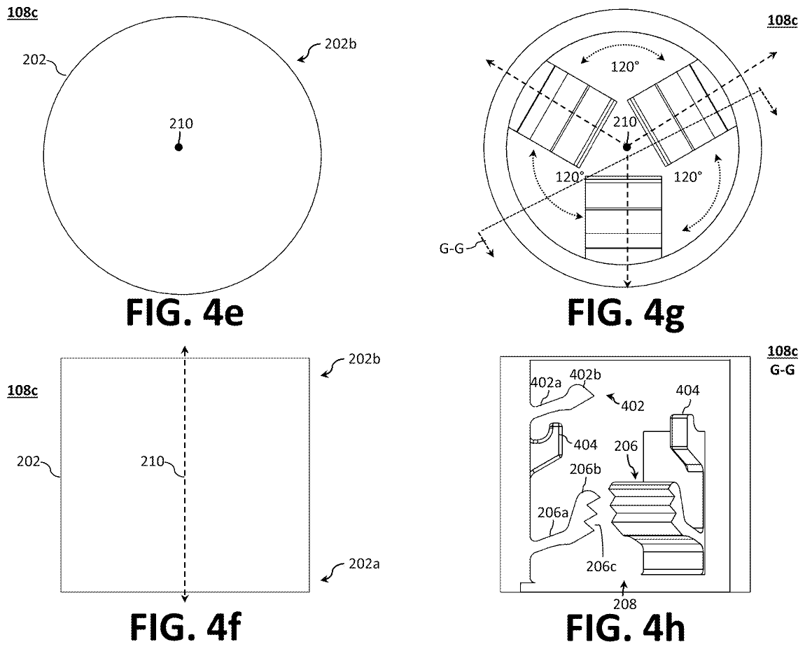

FIGS. 4a through 4g illustrate an example stud fastener 108c. FIG. 4a illustrates a topside isometric view of the stud fastener 108c, while FIG. 4b illustrates an underside isometric view thereof. FIGS. 4c and 4d illustrate, respectively, cross-sectional views of the stud fastener 108c taken along cutline E-E (FIG. 4a) and cutline F-F (FIG. 4b). FIGS. 4e through 4g illustrate, respectively, top plan, side elevation, and bottom plan views of the stud fastener 108c. FIG. 4h illustrates a cross-sectional view of the stud fastener 108c taken along cutline G-G (FIG. 4g). The stud fastener 108c is configured to receive and engage (or otherwise retain) the second component 104 via the retention features 206 and the stud 112.

The stud fastener 108c can be provided as a separate fastener that can be attached to a component at the base end 202b, or instead be integrated with the first component 102 as described above. As illustrated, the stud fastener 108c generally comprises a body 202 that defines (or otherwise includes) a hollow space 208 with three or more retention features 206. In this example, the body 202 is again illustrated as a hollow barrel generally defining a cylindrical sidewall 212. In this example, the base end 202b is closed.

The example stud fastener 108c of FIGS. 4a through 4f is substantially the same as the 3-legged stud fastener 108a of FIGS. 2a through 2f, except that the stud fastener 108c further comprises one or more secondary retention features 402 and one or more shims 404. The plurality of retention features 206 and secondary retention features 402 extend inwardly from an interior surface of the cylindrical sidewall 212 into the hollow space 208 to retain the stud 112. As illustrated, the secondary retention features 402 are vertically offset or spaced relative to the plurality of retention features 206 and are configured to deflect outward from the central longitudinal axis 210 as the stud 112 passes through the hollow space 208. The retention features 206 and secondary retention features 402 are each inwardly biased and resiliently connected to the body 202. The shims 404 similarly extend inwardly from an interior surface of the cylindrical sidewall 212 into the hollow space 208 to retain the stud 112, but are rigidly coupled to the cylindrical sidewall 212 and serve to guide the post during insertion and mitigate side-to-side movement.

As illustrated, each of the secondary retention features 402 includes a secondary return arm 402a and a secondary foot 402b. In some examples, while not illustrated, one or more friction features can be provided on the secondary foot 402b (e.g., akin to the described friction features 206c). In some examples, as illustrated, three retention features 206 are arranged about the central longitudinal axis 210 and spaced from one another by 120 degrees (as best illustrated in FIG. 4g). Similarly, the secondary retention features 402 and shims 404 may be aligned vertically with one or more of the three retention features 206. As a result, the secondary retention features 402 and shims 404 can be arranged about the central longitudinal axis 210 and spaced from one another by 120 degrees.

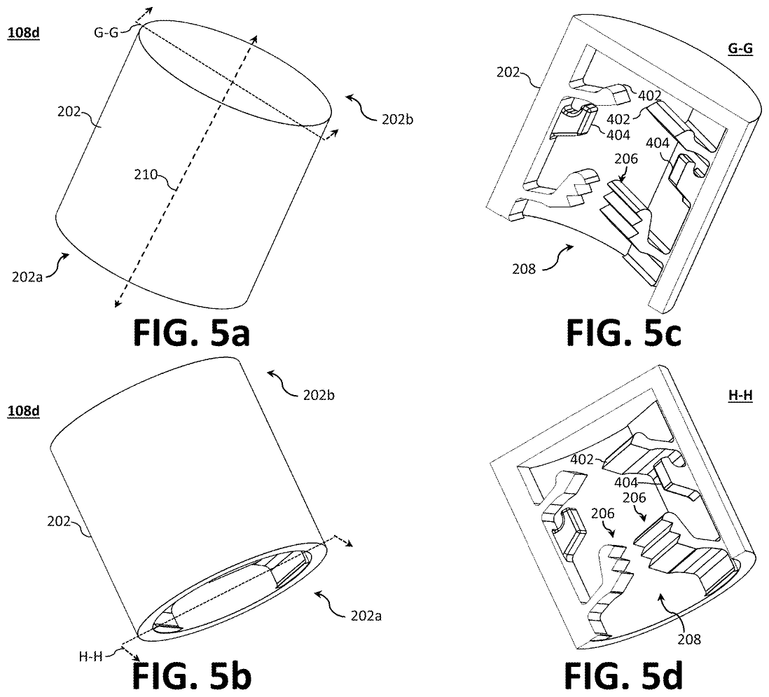

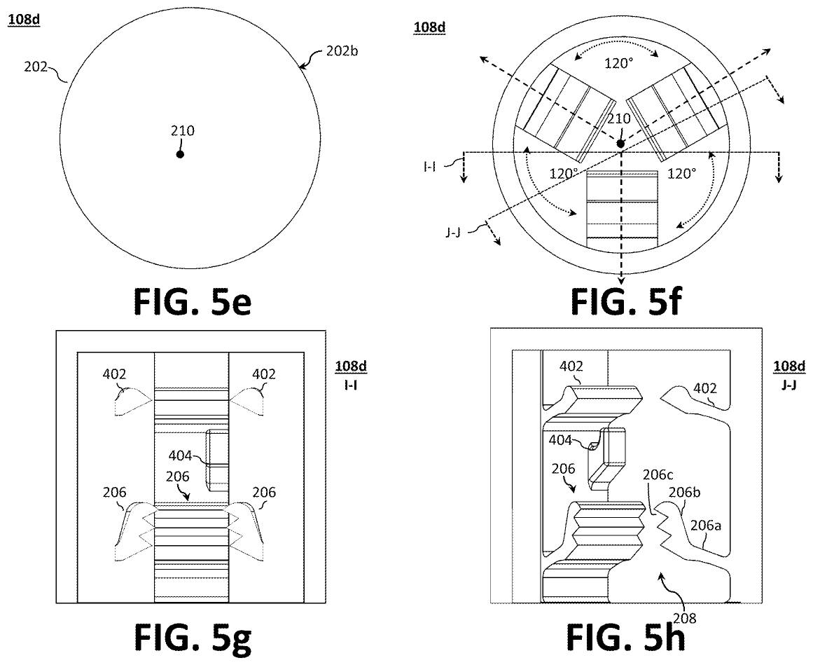

FIGS. 5a through 5h illustrate an example stud fastener 108d. FIG. 5a illustrates a topside isometric view of the stud fastener 108d, while FIG. 5b illustrates an underside isometric view thereof. FIGS. 5c and 5d illustrate, respectively, cross-sectional views of the stud fastener 108d taken along cutline G-G (FIG. 5a) and cutline H-H (FIG. 5b). Figures through 5f illustrate, respectively, top plan and bottom plan views of the stud fastener 108d. FIGS. 5g and 5h illustrate, respectively, cross-sectional views of the stud fastener 108d taken along cutline I-I (FIG. 5f) and cutline J-J (FIG. 5f). The stud fastener 108d is configured to receive and engage (or otherwise retain) the second component 104 via the retention features 206 and the stud 112. The example stud fastener 108d of FIGS. 5a through 5h is substantially the same as the stud fastener 108c of FIGS. 4a through 4f, except that the stud fastener 108d provides both a secondary retention feature 402 and a shim 404 for each retention features 206. As illustrated, each of the three retention features 206 is arranged about the central longitudinal axis 210 and spaced from one another by 120 degrees (as best illustrated in FIG. 4g) and vertically with both a secondary retention feature 402 and a shim 404.

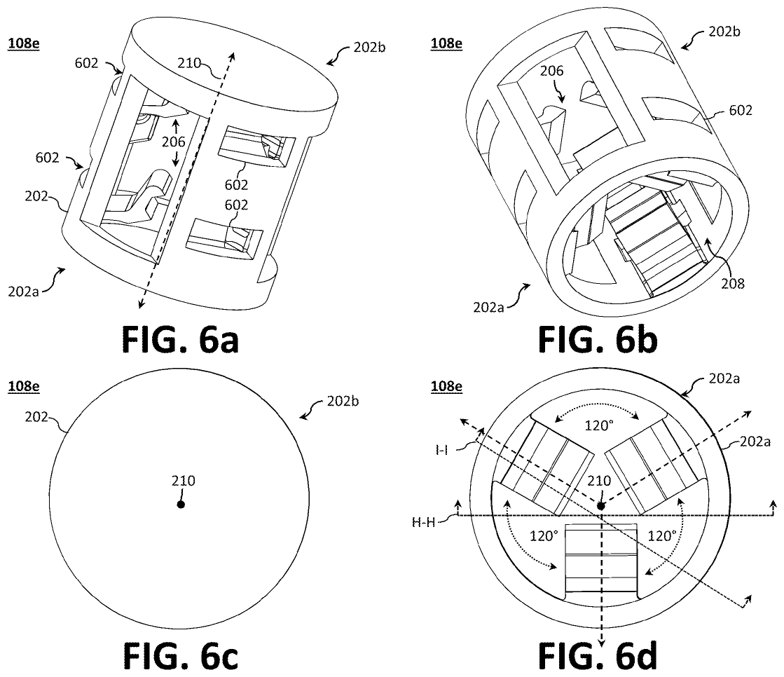

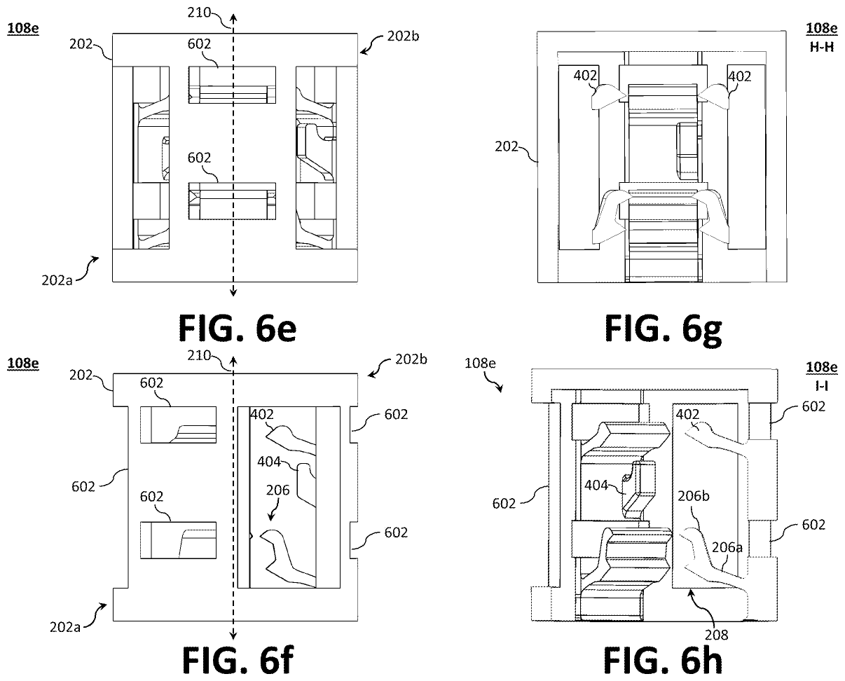

FIGS. 6a through 6h illustrate an example stud fastener 108e with reduced material. FIG. 6a illustrates a topside isometric view of the stud fastener 108e, while FIG. 6b illustrates an underside isometric view thereof. FIGS. 6c through 6f illustrate, respectively, top plan, bottom plan, first side, and second side views of the stud fastener 108e. FIG. 6g illustrates a cross-sectional view of the stud fastener 108e taken along cutline H-H (FIG. 6d), while FIG. 6h illustrates a cross-sectional view of the stud fastener 108e taken along cutline I-I (FIG. 6d). The stud fastener 108e is configured to receive and engage (or otherwise retain) the second component 104 via the retention features 206 and the stud 112.

The example stud fastener 108d of FIGS. 6a through 6h is substantially the same as the stud fastener 108 d of FIGS. 5a through 5g, except that the stud fastener 108d comprises one or more windows 602 (e.g., cut outs or openings) formed in or on the surface of the body 202. For example, the cylindrical sidewall 212 may be formed with one or more windows 602 that serve to reduce the amount of material needed to fabricate the 3-legged stud fastener 108a, thus reducing material cost and weight.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A stud fastener for attaching a first component to a stud of a second component, the stud fastener comprising:
a body defining a central longitudinal axis, wherein the body includes a sidewall that defines a hollow space configured to receive the stud; and
three or more retention features resiliently coupled to an interior surface of the sidewall and configured to retain the stud within the hollow space,
wherein each of the three or more retention features are angled toward the central longitudinal axis and are configured to deflect outward from the central longitudinal axis as the stud passes through the hollow space.

2. The stud fastener of claim 1, wherein the three or more retention features are spaced about the central longitudinal axis from one another by 120 degrees.

3. The stud fastener of claim 1, wherein the body defines a recess within the sidewall.

4. The stud fastener of claim 3, wherein each of the three or more retention features are coupled to the body within the recess.

5. The stud fastener of claim 1, wherein the body and the three or more retention features are fabricated as a unitary structure via an additive manufacturing technique.

6. The stud fastener of claim 1, wherein each of the one or more retention features includes a return arm resiliently connected to the body and configured to deflect as the as the stud passes through the hollow space.

7. The stud fastener of claim 6, wherein each of the retention features 206 comprises a foot position at a distal end of the return arm.

8. The stud fastener of claim 7, wherein the foot comprises one or more friction features.

9. The stud fastener of claim 1, further comprising one or more secondary retention features vertically offset from the three or more retention features.

10. The stud fastener of claim 9, at least one of the one or more secondary retention features is aligned vertically with each of the three or more retention features.

11. The stud fastener of claim 9, wherein each of the one or more secondary retention features comprises a secondary return arm and a secondary foot.

12. The stud fastener of claim 1, further comprising one or more shims vertically offset from the three or more retention features.

13. The stud fastener of claim 12, at least one of the one or more shims is aligned vertically with each of the three or more retention features.

14. The stud fastener of claim 1, wherein the body defines a leading end that is open to receive the stud and a base end.

15. The stud fastener of claim 14, wherein the base end is closed.

16. The stud fastener of claim 14, wherein the base end is open.

17. The stud fastener of claim 14, wherein the leading end of the body is chamfered along an inner perimeter to align and guide the stud during assembly.

18. The stud fastener of claim 1, wherein the sidewall defines a first inner diameter that corresponds to an outer diameter of the stud to mitigate side-to-side movement of a distal end of the stud once assembled.

19. The stud fastener of claim 1, wherein the sidewall defines one or more windows.

20. The stud fastener of claim 1, wherein the stud fastener is fabricated as a unitary structure with the first component via an additive manufacturing technique.
